(19) United States
(12) Patent Application Publication
(10) Pub. No.: US 2017/0300199 A1
(43) Pub. Date: Oct. 19, 2017

(54) METHOD AND APPARATUS TO TRANSFER DATA FROM A FIRST COMPUTER STATE TO A DIFFERENT COMPUTER STATE

(71) Applicant: Maria Francisca JONES, Middlesex (GB)

(72) Inventors: Maria Francisca JONES, Middlesex (GB); Alexander JONES, Middlesex (GB)

(21) Appl. No.: 15/642,235

(22) Filed: Jul. 5, 2017

Related U.S. Application Data
(63) Continuation-in-part of application No. 15/395,321, filed on Dec. 30, 2016.

(30) Foreign Application Priority Data
Dec. 31, 2015 (GB) 1523166.5

(51) Int. Cl. G06F 3/0482; G06F 9/44; H04L 12/26

(52) U.S. Cl. CPC G06F 3/0482; G06F 9/4443

(57) ABSTRACT

A method to transfer data from a first computer program state when an program is generating a display on a user interface, the method comprising executing an interface object to display a representation of an interface object overlaid on a region of the display generated by the program; receive a user input to select data displayed on the display generated by the program; load the selected data into a data store of the interface object; receive a user transition input to cause the program to transition to generate a different display or to execute a different program to generate a different display, the different display representing a different computer program state; maintain the representation of the interface object overlaid on the different display; receive a user unloading input to select to unload at least some of the stored data for use in the different computer state; and unload the data as an input to the program displaying the different display in the different computer state.

### RELATED APPLICATIONS

This application is a continuation in part of U.S. patent application Ser. No. 15/395,321 filed on Dec. 30, 2016 and entitled “DIRECT INTEGRATION SYSTEM”, which claims priority to Great Britain patent application GB1523166.5 filed Dec. 31, 2016, the contents of which are hereby incorporated by reference in their entirety.

### FIELD OF THE INVENTION

The present disclosure relates to methods and apparatuses to transfer data from a first computer state to a different computer state.

### BACKGROUND INFORMATION

The ease of use of computing devices, including computers, laptops tablets, personal digital assistants and mobile devices and telephones is very important. Simplifying processes that require multiple steps requiring the user to remember complex sequences of actions is to be avoided.

Users can need to move from one computer state, such as a displayed output of one program to another computer state, such as a different state of the same program or a different program many times when using a computing device. The usability of the computing device can be greatly enhanced with a well-designed user interface.

### SUMMARY OF THE INVENTION

One aspect provides a method to transfer data from a first computer program state when a program is generating a display on a user interface, the method comprising executing an interface object to display a representation of an interface object overlaid on a region of the display generated by the program; receive a user input to select data displayed on the display generated by the program; load the selected data into a data store of the interface object; receive a user transition input to cause the program to transition to generate a different display or to execute a different program to generate a different display, the different display representing a different computer program state; maintain the representation of the interface object overlaid on the different display; receive a user unloading input to select to unload at least some of the stored data for use in the different computer state; and unload the data as an input to the program displaying the different display in the different computer state.

Another aspect provides apparatus for transferring data from a first computer program state when an program is generating a display on a user interface, the apparatus comprising at least one processor; and a memory storing instructions, which instructions being executable by the at least one processor to execute an interface object to display a representation of an interface object overlaid on a region of the display generated by the program; receive a user input to select data displayed on the display generated by the program; load the selected data into a data store of the interface object; receive a user transition input to cause the program to transition to generate a different display or to execute a different program to generate a different display, the different display representing a different computer program state; maintain the representation of the interface object overlaid on the different display; receive a user unloading input to select to unload at least some of the stored data for use in the different computer state; and unload the data as an input to the program displaying the different display in the different computer state.

A further aspect provides a method to transfer data between computer program states, the method comprising executing an interface object to load at least one application; executing one of the loaded applications in a first computer program state to generate a display on a user interface; display a representation of an interface object overlaid on a region of the display generated by the application; receive a user input to select data displayed on the display generated by the application; load the selected data into a data store of the interface object; receive a user transition input to cause the application to transition to generate a different display or to execute a different loaded application to generate a different display, the different display representing a different computer program state; maintain the representation of the interface object overlaid on the different display; receive a user unloading input to select to unload at least some of the stored data for use in the different computer state; and unload the data as an input to the application displaying the different display in the different computer state.

A further aspect provides apparatus for transferring data from a first computer program state when an program is generating a display on a user interface, the apparatus comprising at least one processor; and a memory storing instructions, which instructions being executable by the at least one processor to execute an interface object to load at least one application; executing one of the loaded applications in a first computer program state to generate a display on a user interface; display a representation of an interface object overlaid on a region of the display generated by the application; receive a user input to select data displayed on the display generated by the application; load the selected data into a data store of the interface object; receive a user transition input to cause the application to transition to generate a different display or to execute a different loaded application to generate a different display, the different display representing a different computer program state; maintain the representation of the interface object overlaid on the different display; receive a user unloading input to select to unload at least some of the stored data for use in the different computer state; and unload the data as an input to the application displaying the different display in the different computer state.

Another aspect of the invention provides a carrier medium or a storage medium carrying code executable by a processor to carry out the deferred search method.

### BRIEF DESCRIPTION OF THE DRAWINGS

FIG. 1 is a schematic diagram illustrating an interface object code module according to one embodiment;

FIG. 2 is a schematic diagram illustrating a computer system utilizing the interface object according to one embodiment;

FIG. 3 is a flow diagram of a method using the interface object according to one embodiment;

FIG. 4 is a schematic diagram illustrating a web based system using the interface object according to one embodiment;

FIGS. 5A and 5B are a flow diagram of a method using the system of FIG. 4 according to one embodiment;

FIGS. 6A to 6D are user interfaces generated during the method according to one embodiment;

FIGS. 7A and 7B are user interfaces generated during the method according to another embodiment; and

FIG. 8 is a schematic diagram of a basic computing device for use in one embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

In the following embodiments, data is described as being stored in at least one database. The term database is intended to encompass any data structure (and/or combinations of multiple data structures) for storing and/or organizing data, including, but not limited to, relational databases (e.g., Oracle databases, mySQL databases, etc.), non-relational databases (e.g., NoSQL databases, etc.), in-memory databases, spreadsheets, as comma separated values (CSV) files, eXtendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores. A “file system” may control how data is stored and/or retrieved (for example, a disk file system like FAT, NTFS, optical discs, etc., a flash file system, a tape file system, a database file system, a transactional file system, a network file system, etc.). For simplicity, the disclosure is described herein with respect to databases. However, the systems and techniques disclosed herein may be implemented with file systems or a combination of databases and file systems.

In the following embodiments, the term data store is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

The functions or algorithms described herein are implemented in hardware, software or a combination of software and hardware in one embodiment. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides and method computer apparatus and carrier medium method to operate to transfer data from a first computer program state when an program is generating a display on a user interface. An interface object is executed as code to display a representation of an interface object overlaid on a region of the display generated by the program; to receive a user input to select data displayed on the display generated by the program; to load the selected data into a data store of the interface object; to receive a user transition input to cause the program to transition to generate a different display or to execute a different program to generate a different display, the different display representing a different computer program state; to maintain the representation of the interface object overlaid on the different display; to receive a user unloading input to select to unload at least some of the stored data for use in the different computer state; and to unload the data as an input to the program displaying the different display in the different computer state.

Hence the generalized embodiment provides a method by which a user can store data displayed on a user interface when a program is executed in one state and carry it over in a visible manner to another display for the program or a different program in a different computer state, so that the data can be unloaded or copied as an input the user interface in the different computer program state. The persistent visible nature of the representation of the interface object assist the user in understanding that the interface object is acting as a carrier of the data from one display to the next. In this way data such as text or image data displayed in one user interface display can be carried over to be used as an input in another display, with the user seeing it being carried by the presence of the representation of the interface object.

Data may be stored identifying a next computer program state for each of a plurality of current program states. The term ‘current program state’ is only intended to indicate that when it is executed at the current program state the next program state is the state to follow it in response to a user input. The user input can comprise a number of well-defined user actions for each current state, each corresponding an instructions to transition to one of a number of next states. Examples of such well-defined user defined actions can include movement of a cursor in specified directions or pattern or movement of the representation of the interface object on the display (e.g. a drag operation or swipe operation on a touch screen display). Alternatively, the well-defined user actions could be keyboard key presses such as F1, F2 etc.

In order to provide enhanced awareness to the user, the representation of the interface object can be modified to indicate when data is loaded into the interface object.

The representation of the interface object can comprise any suitable image or graphic and can even be an animated graphic or video. The representation can be of small size such as an icon so as not to consume too much of the display space and to leave most of it available for the display generated by the program. The representation can comprise any suitable graphic, such as a cart for transactions, a folder or brief case for documents or text, a ball for a ball sport, or a vehicle or person. Such a graphic is capable of being moved across a display to indicate the transition to the next display for the next program state and the graphic can be animated to show movement, such as a walking person, a rolling ball, or a driving vehicle. The graphic can also be modified to show that data is being carried, e.g. a basket or cart can be modified to show something in it, a person could be illustrated as carrying something etc. Also, the animation can include audio.

An input can be received to display information on the data loaded into the interface object and the information can be displayed. The information can simply be a title or short summary or, it could be the data itself. The user could select to display the information simply by selecting e.g. clicking on or tapping the representation (graphic or icon) of the interface object. In this case, the user input to unload the data to the display for the next program state can comprise selections of at least some of the displayed information.

The interface object can be associated with a user and can store identification information and information on actions by the user, to for user history data indicating user preferences and behaviour. The interface object can be associated with an advertiser and an advertisement can be output as at least part of the representation (e.g. graphic or icon) of the interface object and the stored information on the user can be transmitted to the advertiser. In response, the advertiser can transmit updated advertisements to the interface object for the display of updated advertisements as part of the representation. In this way, an advertiser can provide a user with a useful interface application module having certain functionalities, such as predefined next actions in return for allowing the advertiser to target advertisements for the user.

In one embodiment, the interface object, when loaded as a program module, can automatically load at least one program so that the interface object assist the user in providing a processing environment that is holistic with the interface object aimed for use with the loaded applications. One example would be an interface object aimed for office work. The interface object may automatically open a word processing program and a presentation program. The interface application may have certain well defined user input actions that are predefined to cause a transition from the interface object being overlaid on a word processed document so that when the content of the document is loaded into the interface object, the user can input the instruction to automatically open the presentation application so that the interface object is overlaid on the displayed interface with the data content available for unload to the presentation application.

The user interface can, in one embodiment, be provided as a conventional web site having a displayed output and a pointer device and keyboard input by a user. In alternative embodiments, the interface can be provided by any form of visual output and any form of input as a user input, such as keyboard, touch screen, pointer device (such as a mouse, trackball, trackpad, or pen device), audio recognition hardware and/or software to recognize a sounds or speech from a user, gesture recognition input hardware and/or software, etc.

In one embodiment, the user interface can be provided using the method disclosed in co-pending US patent application number U.S. Ser. No. 15/395,343, filed 30 Dec. 2016 and entitled “USER INTERFACE METHOD AND APPARATUS”, the content of which is hereby incorporated by reference in its entirety. The user interface of U.S. Ser. No. 15/395,343 can provide a means by which the user interacts with the system for inputs and selections.

In one embodiment, the method and system can be used with the electronic transaction method and system disclosed in copending US patent application number U.S. Ser. No. 15/395,487, filed 30 Dec. 2016 and entitled “AN ELECTRONIC TRANSACTION METHOD AND APPARATUS”, the content of which is hereby incorporated by reference in its entirety. The transaction method and system of U.S. Ser. No. 15/395,487 can be the transition from a first program state to a next program state and the data loaded into the interface object can be transactional data, e.g. the basket or cart in the transaction system containing product information for products (including tangible products, virtual products and services) to be purchased on checkout.

In one embodiment, the method and system can be used with the method and system disclosed in copending US patent application number, filed on the same date as this application and entitled “EVENT BASED DEFERRED SEARCH METHOD AND SYSTEM”, the content of which is hereby incorporated in its entirety.

Specific embodiments will now be described with reference to the drawings.

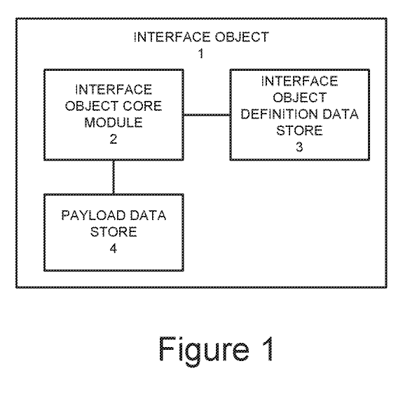

FIG. 1 is a schematic diagram illustrating an interface object code module according to one embodiment.

FIG. 1 illustrates the code structure of an interface object 1. The interface object comprises a core module 2 to perform the function of the interface object and a definition data store 3 storing definitional data for the interface object. The definitional data can comprise to following data:
Object type data—defining the type of object of which the interface object is an instance for example.
Icon/image/video/audio for the representation of the interface object on the display
Predefined actions in response to predefined user inputs. This defines the user input that will be recognized to cause the interface object to move the computing device to the next program state e.g. swipe right to take the program state to the checkout web page to a transaction implementation. The next program states can comprise a sequence of next program states so that when the user makes the selection to a next program state and the computing device makes the transition so that the next program state becomes the current program state, the next program state in the sequence will become the next program state responsive to the predefined user input.
Predefined applications to load—this data can identify any applications to load when the interface object is loaded to be ready for processing as part of a transition or sequence of transitions to program states.
User data can include for example:
   a user identifier
   user information including name, date of birth and contact information
   User preferences—these can be input by a user
   Use history—stored actions by the user
Advertiser information can include for example:
   Advertiser identifier
   Electronic contact information for the direction of the transmission of user information
   Advertisement(s) to be displayed—there can be a number that can be displayed randomly or in a defined sequence as part of the representation of the interface object or even as a separate overlaid advertisement. The advertisements will be updated by downloaded updated advertisements from the advertiser in response to unloaded user data.

FIG. 1 also illustrates a payload data store 4 connected to the core module 2. The payload data store 4 stores the data selected for loading into the interface object by the user input. The data can be of one or more data types, such as text or image data, or even video data. The data can even comprise a code object if the user interface enables the user to select such a code object from the display and such a code object is to be unloaded to a next program state.

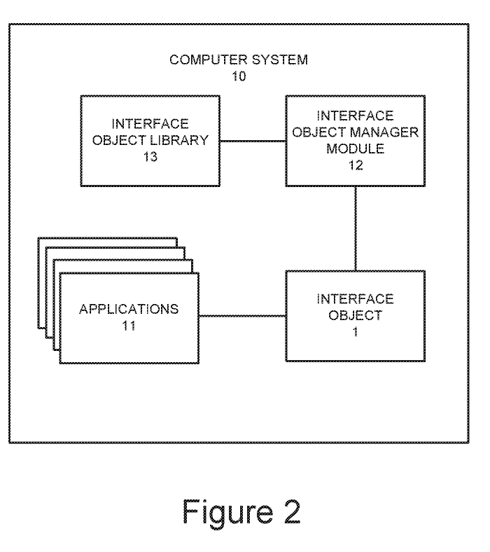

FIG. 2 is a schematic diagram illustrating a computer system 10 utilizing the interface object 1 according to one embodiment. The computer system implements each of the code modules illustrated in FIG. 2.

The interface object 1 is linked to an interface object manager module 12. The interface manager module 12 is a program is executed and provides a user interface that allows a user to select to install the interface object 1. The interface object manager module 12 interfaces to an interface object library 13 storing a plurality of interface object code modules that can be selected and instantiated by the user as the interface object 1. The interface object operates persistently to interface to applications 11 running on the computer system 10 so as to be displayed overlaid over the graphical output of the applications 11 and to be able to access any data displayed by the applications for loading into the payload data store 4.

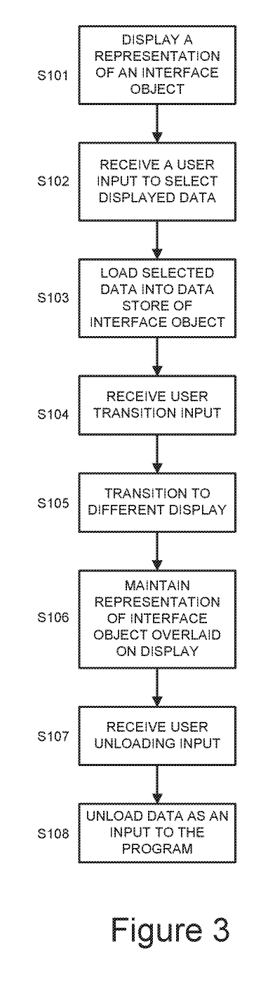

FIG. 3 is a flow diagram of a method using the interface object according to one embodiment. The process is implemented on a computer system, a computer apparatus or a computer device.

In step S101 a representation of an interface object is displayed overlaid on a current display output of a program (or operating system). In step S102 a user input is received to select displayed data and in step S103 the selected data is loaded into the data store 4 of the interface object 1. In step S104 a user transition input is received and in step S105 the computer system, apparatus or device transitions the program state to output a different display in response to the transition input. In this display state, in step S106, the representation of the interface object is maintained displayed overlaid on the display in the different state. In step S107 a user unloading input is received and in step S108 at least some of the data stored in the payload data store 4 of the interface object 1 is unloaded and input into the program operating in the different program state.

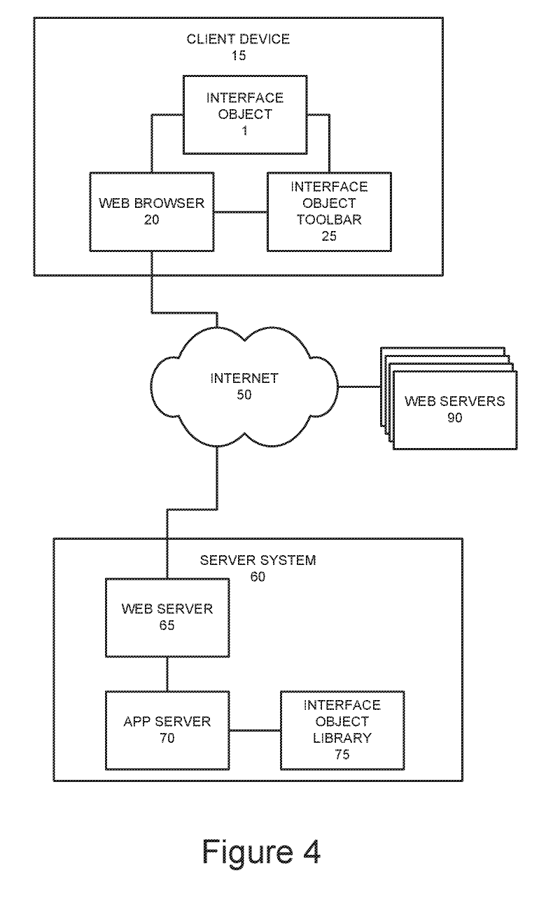

FIG. 4 is a schematic diagram illustrating a web-based system using the interface object 1 according to one embodiment.

A client device 15 comprising a computer device including computers, laptops tablets, personal digital assistants and mobile devices and telephones is connected over a network such as the internet 50 to a server system 60 and to a number of web servers 90 hosting web pages. A web browser 20 is implemented in the client device 15 to access and render the web pages on the web servers 90. An interface object toolbar 25 is installed as an add on to the web browser 20 to give a user access to select to implement an interface object 1 which is then implemented as an add on to the web browser 20 as shown in FIG. 4.

The server system 60 includes a web server 65 to provide a web interface for the web browser 20 of the client device 15. An app server 70 is provided connected to the web server 65 to provide active web pages for the web server 65 and to access an interface object library 75. In this way, a user of the client device 15 can use the web browser 20 to access the web server 65 to download new interface object code from the interface object library 75.

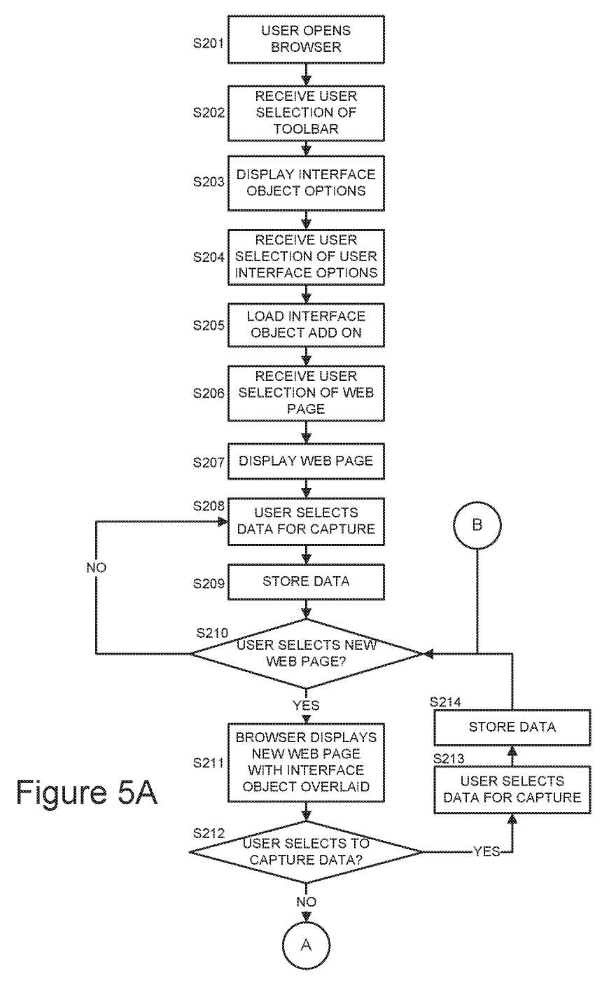

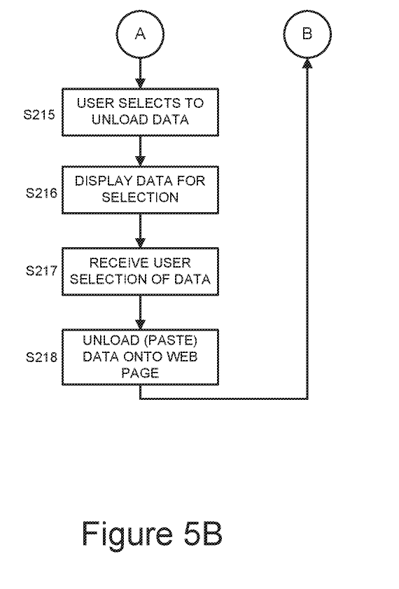

FIGS. 5A and 5B are a flow diagram of a method using the web-based system of FIG. 4 according to one embodiment.

In step S210 a user opens the web browser 20 and in step S202 a user selection of the toolbar 25 is received. In step S203 interface object options are displayed and in step S204 user selections of interface object options are received so that in step S205 an interface object 1 can be loaded as an add on to the web browser 20. In step S206 a user selection of a web page hosted by one of the web servers 90 is received and in step S207 the web page code is received and rendered by the web browser 20. In step S208 a user selection to capture data displayed on the web page is received and in step S209, the data is loaded into the payload data store 4 of the interface object 1. The process then waits to see if a user selects a new web page in step S210. If not the process allows a user to capture more than one piece of data of any data type from the web page by returning to step S208. If a user selection of a new web page is received in step S210, in step S211 the browser displays the new web page overlaid with the representation of the interface object. The client device 15 has thus changed program state and browser generates a different display: a different web page. In step S212, the process waits to determine whether a user selection to capture more data is received. Is so, in step S213 the user selection of the data to be captured and loaded into the payload data store 4 of the interface object is received and in step S214 the data is loaded into the payload data store 4. The process then returns to step S210 to wait to determine whether the user selects a new web page.

If in step S212 the user does not select to capture more data from the web page, in step S215 a user selection to unload the data is received and in step S216 the data in the payload data store 4 is displayed to allow some or all of it to be selected. In step S217 a user selection of some or all of the data in the payload data store 4 is selected and in step S218 the data is unloaded or pasted into a selected section of the web page e.g. a form or input box.

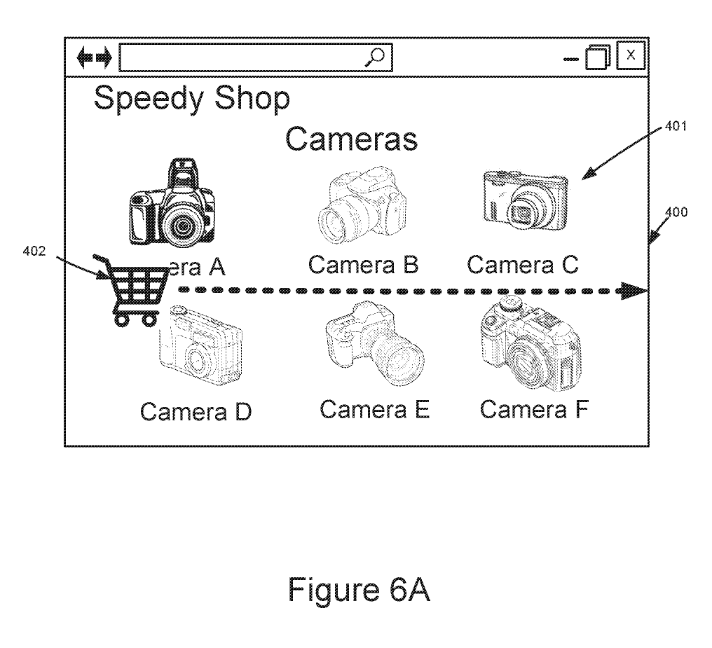

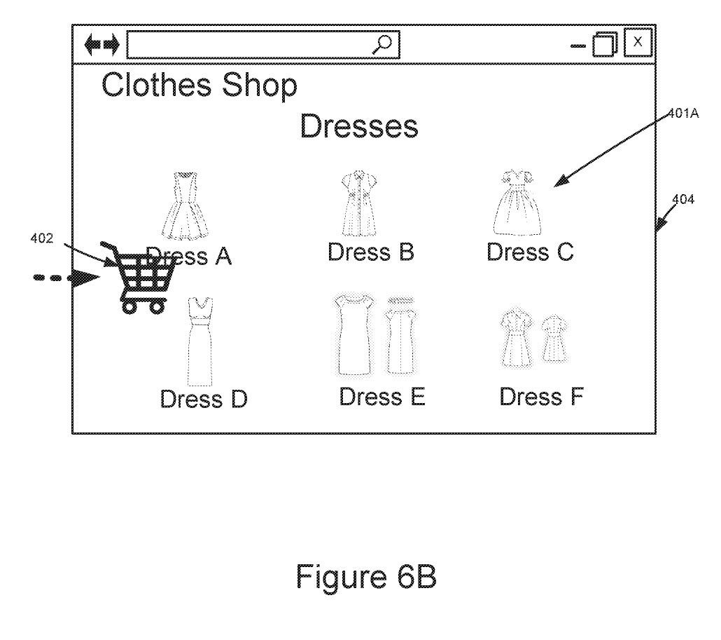

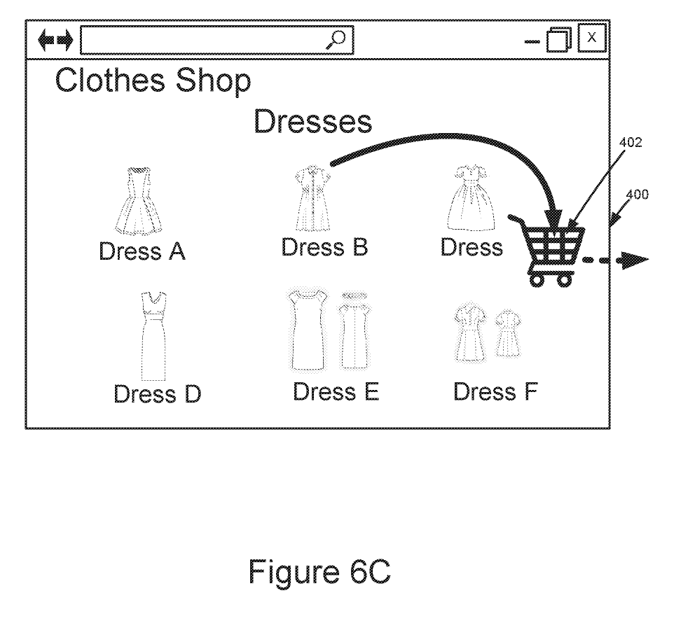

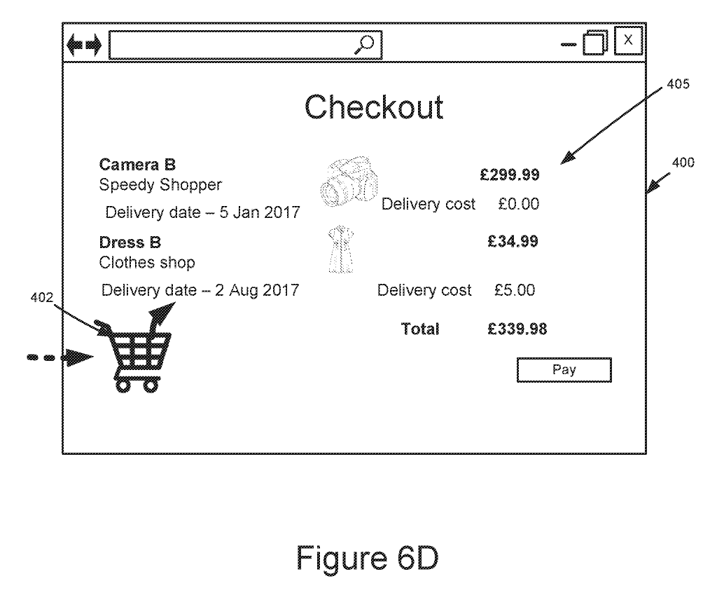

FIGS. 6A to 6D are user interfaces generated during the method according to one embodiment. This embodiment is a web-based transaction method.

FIG. 6A illustrates an interface 400 in the form of a displayed web page displaying information 401 on products in the form of cameras available from one merchant. A representation of an interface object 402 is displayed overlaid on the web page 400 in the form of an icon or image of a cart or trolley. A user is able to interact with the interface object 402 to move it across the display as indicated by the arrow. The user selects data from the web page 400 by making a selection of a product (Camera B) to purchase. The data is loaded into the interface object data store so that the shopping cart includes information on camera B to purchase. The operation of selection can comprise dragging and dropping the icon of camera B into the shopping cart 402.

In order to transition the display and the program state, a user can drag the shopping cart 402 across the display. This user input action causes a transition to a next state defined in the interface object data and the next web page is displayed as shown in FIG. 6B with the interface object (shopping cart) 402 overlaid on the left hand side. The next web page is a page for a merchant (the same merchant or a different one) selling dresses 401A.

As shown in FIG. 6C, the user can select data to add to the interface object data store by dragging and dropping a selection of a dress into the shopping cart 402. The user can then select to transition to a next program state by dragging the representation of the interface object across the display as shown in FIG. 6C to transition to the display of FIG. 6D.

In FIG. 6D the user interface 400 displays the programs state of a web checkout page. The cart (interface object representation) 402 is illustrated as appearing on the left hand side of the display as the transition occurs to this web page and the data stored in the interface object is unloaded onto the web page as the transaction data to checkout. The user is able to confirm the purchase by selecting to pay for the goods in the conventional manner by selecting to pay. The difference over convention shopping carts is that the cart 402 can be interacted with to cause the web page transition. Also, the cart can be used across multiple web sites and merchants subject to suitable predefining of the transitions in the interface object definition data. The image of the cart 402 can also be modified when product information is placed in it to show that product information is loaded in it.

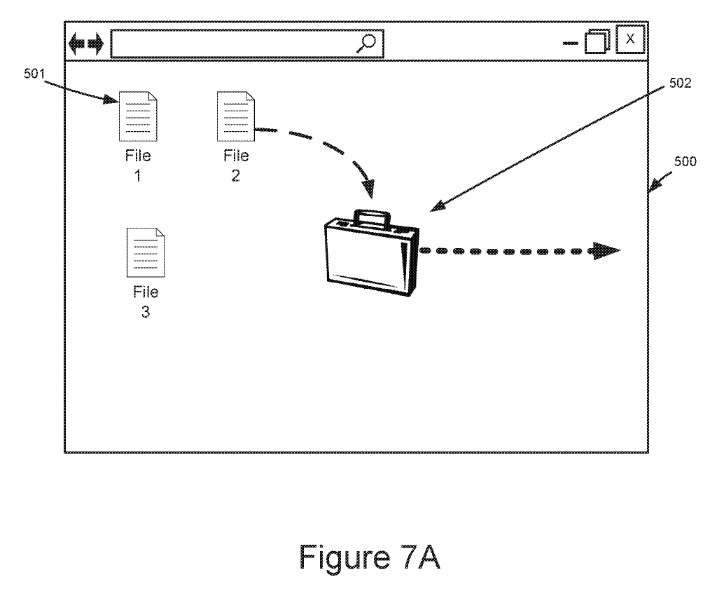

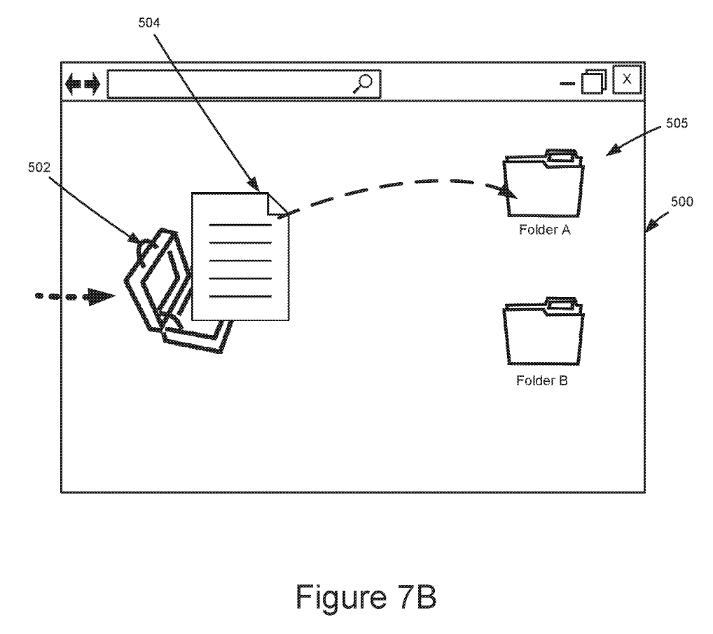

FIGS. 7A and 7B are user interfaces generated during the method according to another embodiment. This embodiment relates to the processing of documents, such as in an office application.

FIG. 7A illustrates an interface 500 in the form of a computer screen displaying files 501 that can be selected for processing. The interface object representation in this embodiment is illustrated as a briefcase 502. A user can select a file 501 for loading into the interface object. This is shown in FIG. 7A as a drag and drop operation by the arrow from file 2 to the briefcase 502. The user can then select to transition to a next program state to display a different display by for example dragging or swiping the briefcase 501 across the display as shown in FIG. 7A. The program and display transition in this embodiment is predefined to transition to the display illustrated in FIG. 7B. The briefcase 502 appears overlaid on the display on the left hand side. In this example the user has selected to view the content of the interface object and as shown the image of the interface object can be modified to reflect this selection. In this embodiment, the response is to illustrate the briefcase as open and to illustrate information 504 on the file that is stored in the interface object. The user is then able to select the file 504 to be unloaded into a suitable location in the interface displayed. In this embodiment, this comprises a drag and drop operation to move the file 504 to a Folder A 505. In this embodiment, the program operating to generate the display over which the interface object representation is displayed is an operating system, such as Linux®, Lion® or Linux®.

In embodiments where the interface object operates in on a standalone machine in which applications need to be loaded to perform desired processing, the interface object code can include code to launch predefined programs/applications to be ready to be used as program transition targets. For example, in an office environment, for an office interface object, the interface object could preload any one or more of a word processing application, a spreadsheet, a presentation application, a drawing application, an email application etc.

A user is able to use the programs of their computer in the normal way with the interface object representation displayed overlaid on the display output by the programs. This enables a user to navigate to or within a program, web page, document, folder etc and then load data into the interface object from the displayed data. The object can store not just information on the target navigation destination, but also the target data for the display generation in a cache.

Although in the embodiments described above only one interface object and associated representation is described, it is possible for a user to define more than one interface object to perform different functions at the same time and including different predefined program transitions. For example, in an office environment, a user might have a document focused interface object to perform document based functions related to document management and communication and a finance based interface object to perform finance functions. Similarly in a web-based application, a user might have one interface object to perform transactions and another for assisting with internet searching or two for performing different transactions, such as one shopping cart for Katie's Christmas shopping and one for David's Christmas shopping. More than one interface object can be displayed at a time so that each can perform its own function.

The interface object can be provided with a menu to enable a user to select functions that the object is to perform. This can be part of the setup of the object or an object can be defined with a number of similar functions than can be selected from during use.

The method of loading data into the payload data store of an interface object can comprise any method responsive to a user selection, such as cutting and pasting, or dragging and dropping.

Interface objects can be made available for download by advertisers in return for advertisements appearing as part of the interface object representation or as a separate display, such as a banner. The interface objects can include code that can track user actions to store a history of user actions for upload to the advertiser. The tracked actions can include the web pages and sections of the program viewed by the user and the interactions of the user with displayed sections or regions of the displayed information. The advertiser is then able to process the data to determine appropriate targeted advertisements for the user and down load them to the interface object for display to the user. In this way, the users actions can be tracked and advertising targeted to them.

Interface objects are associated with at least one user. In one embodiment, an interface object can be shared by multiple users. In such an arrangement, only one user can use the interface object at a time. The use will need to be tracked at a server and the use is suited to use on the server by multiple users. In a networked environment for multiple users, each user might have their own interface object, but the interface objects of multiple users may be displayed on a shared user interface display.

It can be seen from the above embodiments that the interface object acts as a data carrier with an overlaid displayed representation to guide and inform the user and to enable the user to interact with it at any point in the processing by any program or operating system.

The interface objects can include a function to allow a user to communicate with other users of interface objects or other users more generally. The communication function allows a user to select the interface object by for example clicking on it to open a communication interface or function. Communications can also be sent back as feedback for example to an advertiser that is pushing advertisements to the user using the interface object. The communication function enables the data stored in the payload data store of the interface object to be sent to another computer in a communication.

### Basic Computing Device

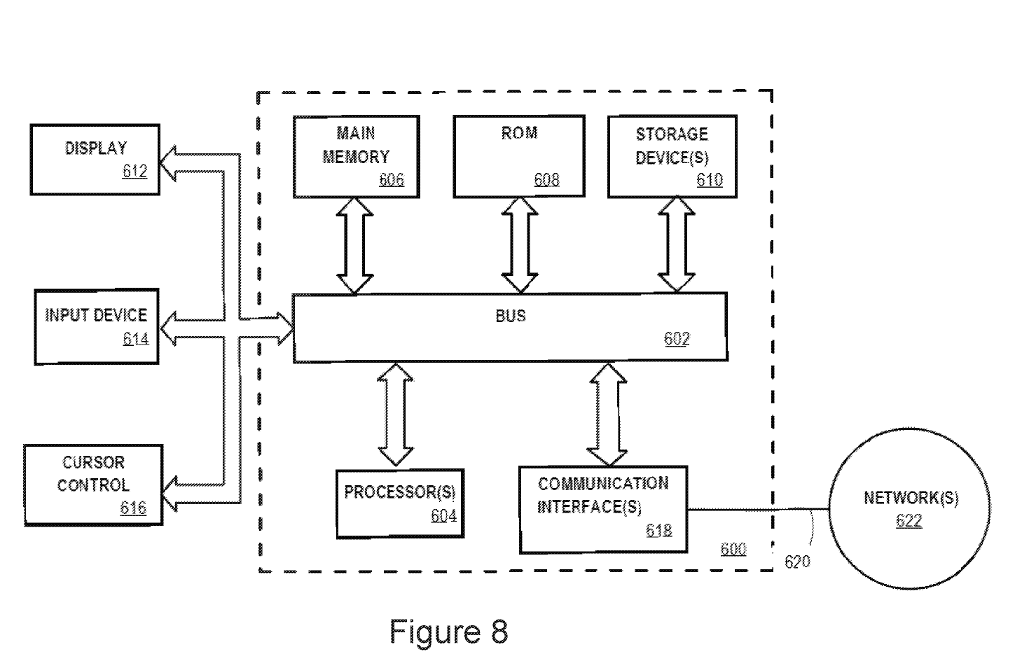

FIG. 8 is a block diagram that illustrates a basic computing device 600 in which the example embodiment(s) of the present invention may be embodied. Computing device 600 and its components, including their connections, relationships, and functions, is meant to be exemplary only, and not meant to limit implementations of the example embodiment(s). Other computing devices suitable for implementing the example embodiment(s) may have different components, including components with different connections, relationships, and functions.

The computing device 600 can comprise any of the servers or the user device as illustrated in FIG. 1 for example.

Computing device 600 may include a bus 602 or other communication mechanism for addressing main memory 606 and for transferring data between and among the various components of device 600.

Computing device 600 may also include one or more hardware processors 604 coupled with bus 602 for processing information. A hardware processor 604 may be a general purpose microprocessor, a system on a chip (SoC), or other processor.

Main memory 606, such as a random access memory (RAM) or other dynamic storage device also may be coupled to bus 602 for storing information and software instructions to be executed by processor(s) 604. Main memory 606 also may be used for storing temporary variables or other intermediate information during execution of software instructions to be executed by processor(s) 604.

Software instructions, when stored in storage media accessible to processor(s) 604, render computing device 600 into a special-purpose computing device that is customized to perform the operations specified in the software instructions. The terms “software”, “software instructions”, “computer program”, “computer-executable instructions”, and “processor-executable instructions” are to be broadly construed to cover any machine-readable information, whether or not human-readable, for instructing a computing device to perform specific operations, and including, but not limited to, application software, desktop applications, scripts, binaries, operating systems, device drivers, boot loaders, shells, utilities, system software, JAVASCRIPT, web pages, web applications, plugins, embedded software, microcode, compilers, debuggers, interpreters, virtual machines, linkers, and text editors.

Computing device 600 also may include read only memory (ROM) 608 or other static storage device coupled to bus 602 for storing static information and software instructions for processor(s) 604.

One or more mass storage devices 610 may be coupled to bus 602 for persistently storing information and software instructions on fixed or removable media, such as magnetic, optical, solid-state, magnetic-optical, flash memory, or any other available mass storage technology. The mass storage may be shared on a network, or it may be dedicated mass storage. Typically, at least one of the mass storage devices 610 (e.g., the main hard disk for the device) stores a body of program and data for directing operation of the computing device, including an operating system, user application programs, driver and other support files, as well as other data files of all sorts.

Computing device 600 may be coupled via bus 602 to display 612, such as a liquid crystal display (LCD) or other electronic visual display, for displaying information to a computer user. In some configurations, a touch sensitive surface incorporating touch detection technology (e.g., resistive, capacitive, etc.) may be overlaid on display 612 to form a touch sensitive display for communicating touch gesture (e.g., finger or stylus) input to processor(s) 604.

An input device 614, including alphanumeric and other keys, may be coupled to bus 602 for communicating information and command selections to processor 604. In addition to or instead of alphanumeric and other keys, input device 614 may include one or more physical buttons or switches such as, for example, a power (on/off) button, a “home” button, volume control buttons, or the like.

Another type of user input device may be a cursor control 616, such as a mouse, a trackball, a cursor or a touch screen, or direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. Other input device embodiments include an audio or speech recognition input module to recognize audio input such as speech, a visual input device capable of recognizing gestures by a user, and a keyboard.

While in some configurations, such as the configuration depicted in FIG. 8, one or more of display 612, input device 614, and cursor control 616 are external components (i.e., peripheral devices) of computing device 600, some or all of display 612, input device 614, and cursor control 616 are integrated as part of the form factor of computing device 600 in other configurations.

In addition to or in place of the display 612 any other form of user output device can be sued such as an audio output device or a tactile (vibrational) output device.

Functions of the disclosed systems, methods, and modules may be performed by computing device 600 in response to processor(s) 604 executing one or more programs of software instructions contained in main memory 606. Such software instructions may be read into main memory 606 from another storage medium, such as storage device(s) 610 or a transmission medium. Execution of the software instructions contained in main memory 606 cause processor(s) 604 to perform the functions of the example embodiment(s).

While functions and operations of the example embodiment(s) may be implemented entirely with software instructions, hard-wired or programmable circuitry of computing device 600 (e.g., an ASIC, a FPGA, or the like) may be used in other embodiments in place of or in combination with software instructions to perform the functions, according to the requirements of the particular implementation at hand.

The term “storage media” as used herein refers to any non-transitory media that store data and/or software instructions that cause a computing device to operate in a specific fashion. Such storage media may comprise non-volatile media and/or volatile media. Non-volatile media includes, for example, non-volatile random access memory (NVRAM), flash memory, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications. A machine readable medium or carrier medium carrying instructions in the form of code can comprise a non-transient storage medium and a transmission medium or signal.

Various forms of media may be involved in carrying one or more sequences of one or more software instructions to processor(s) 604 for execution. For example, the software instructions may initially be carried on a magnetic disk or solid-state drive of a remote computer. The remote computer can load the software instructions into its dynamic memory and send the software instructions over a telephone line using a modem. A modem local to computing device 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor(s) 604 retrieves and executes the software instructions. The software instructions received by main memory 606 may optionally be stored on storage device(s) 610 either before or after execution by processor(s) 604.

Computing device 600 also may include one or more communication interface(s) 618 coupled to bus 602. A communication interface 618 provides a two-way data communication coupling to a wired or wireless network link 620 that is connected to a local network 622 (e.g., Ethernet network, Wireless Local Area Network, cellular phone network, Bluetooth wireless network, or the like). Communication interface 618 sends and receives electrical, electromagnetic, or optical signals that carry digital data streams representing various types of information. For example, communication interface 618 may be a wired network interface card, a wireless network interface card with an integrated radio antenna, or a modem (e.g., ISDN, DSL, or cable modem).

Network link(s) 620 typically provide data communication through one or more networks to other data devices. For example, a network link 620 may provide a connection through a local network 622 to a host computer or to data equipment operated by an Internet Service Provider (ISP). ISP in turn provides data communication services through the world wide packet data communication network now commonly referred to as the “Internet”. Local network(s) 622 and Internet use electrical, electromagnetic or optical signals that carry digital data streams. The signals through the various networks and the signals on network link(s) 620 and through communication interface(s) 618, which carry the digital data to and from computing device 600, are example forms of transmission media.

Computing device 600 can send messages and receive data, including program code, through the network(s), network link(s) 620 and communication interface(s) 618. In the Internet example, a server might transmit a requested code for an application program through Internet, ISP, local network(s) 622 and communication interface(s) 618.

The received code may be executed by processor 604 as it is received, and/or stored in storage device 610, or other non-volatile storage for later execution.

One aspect provides a carrier medium, such as a non-transient storage medium storing code for execution by a processor of a machine to carry out the method, or a transient medium carrying processor executable code for execution by a processor of a machine to carry out the method. Embodiments can be implemented in programmable digital logic that implements computer code. The code can be supplied to the programmable logic, such as a processor or microprocessor, on a carrier medium. One such embodiment of a carrier medium is a transient medium i.e. a signal such as an electrical, electromagnetic, acoustic, magnetic, or optical signal. Another form of carrier medium is a non-transitory storage medium that stores the code, such as a solid-state memory, magnetic media (hard disk drive), or optical media (Compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method to transfer data from a first computer program state when a program is generating a display on a user interface, the method comprising:
executing an interface object to:
display a representation of an interface object overlaid on a region of the display generated by the program;
receive a user input to select data displayed on the display generated by the program;
load the selected data into a data store of the interface object;
receive a user transition input to cause the program to transition to generate a different display or to execute a different program to generate a different display, the different display representing a different computer program state;
maintain the representation of the interface object overlaid on the different display;
receive a user unloading input to select to unload at least some of the stored data for use in the different computer state; and
unload the data as an input to the program displaying the different display in the different computer state.

2. A method according to claim 1, including storing data identifying a plurality of next computer program states for each of a plurality of current computer program states, wherein the user transition input comprises a plurality of user predefined actions, each user defined action to transition from a current computer program state to a next computer program state displaying the different display.

3. A method according to claim 2, wherein the user predefined action comprises a user selection to move the representation of the interface object in a direction on the display to transition from a current computer program state to a next computer program state displaying the different display.

4. A method according to claim 3, wherein the selection to move the representation comprises a drag operation to move the representation to an edge of a display screen.

5. A method according to claim 1, wherein the representation of the interface object is modified to indicate when data is loaded into the interface object.

6. A method according to claim 1, including receiving a user input to display information on the data loaded into the interface object, and displaying the information on the data loaded into the interface object.

7. A method according to claim 6, wherein the user unloading input comprises a selection of at least some of the displayed information on the data loaded into the interface object.

8. A method according to claim 1, wherein, on execution, the interface object loads at least one program including the program and the different program.

9. A method according to claim 1, wherein the interface object is associated with at least one user and stores user identification data, and the method includes storing information on actions by the user.

10. A method according to claim 9, wherein the interface object is associated with an advertiser, and the method includes outputting an advertisement for display as at least part of the representation of the interface object, and transmitting stored information on user actions to the advertiser.

11. A method according to claim 10, including receiving an updated advertisement for display as at least part of the representation of the interface object from the advertiser in response to the transmitted information on user actions.

12. Apparatus for transferring data from a first computer program state when an program is generating a display on a user interface, the apparatus comprising:
at least one processor; and
a memory storing instructions, which instructions being executable by the at least one processor to:
execute an interface object to:
display a representation of an interface object overlaid on a region of the display generated by the program;
receive a user input to select data displayed on the display generated by the program;
load the selected data into a data store of the interface object;
receive a user transition input to cause the program to transition to generate a different display or to execute a different program to generate a different display, the different display representing a different computer program state;
maintain the representation of the interface object overlaid on the different display;
receive a user unloading input to select to unload at least some of the stored data for use in the different computer state; and
unload the data as an input to the program displaying the different display in the different computer state.

13. Apparatus according to claim 12, including instructions executable by the at least one processor to store data identifying a plurality of next computer program states for each of a plurality of current computer program states, wherein the user transition input comprises a plurality of user predefined actions, each user defined action to transition from a current computer program state to a next computer program state displaying the different display.

14. Apparatus according to claim 13, wherein the user predefined action comprises a user selection to move the representation of the interface object in a direction on the display to transition from a current computer program state to a next computer program state displaying the different display.

15. Apparatus according to claim 14, wherein the selection to move the representation comprises a drag operation to move the representation to an edge of a display screen.

16. Apparatus according to claim 12, wherein the representation of the interface object is modified to indicate when data is loaded into the interface object.

17. Apparatus according to claim 12, including instructions executable by the at least one processor to receive a user input to display information on the data loaded into the interface object, and display the information on the data loaded into the interface object.

18. Apparatus according to claim 17, wherein the user unloading input comprises a selection of the displayed information on the data loaded into the interface object.

19. Apparatus according to claim 12, wherein, on execution, the interface object loads at least one program including the program and the different program.

20. Apparatus according to claim 12, wherein the interface object is associated with at least one user and stores user identification data, and including instructions executable by the at least one processor to store information on actions by the user.

21. Apparatus according to claim 20, wherein the interface object is associated with an advertiser, and including instructions executable by the at least one processor to output an advertisement for display as at least part of the representation of the interface object, and transmit stored information on user actions to the advertiser.

22. Apparatus according to claim 21, including instructions executable by the at least one processor to receive an updated advertisement for display as at least part of the representation of the interface object from the advertiser in response to the transmitted information on user actions.

23. A method to transfer data between computer program states, the method comprising:
executing an interface object to:
load at least one application;
execute one of the loaded applications in a first computer program state to generate a display on a user interface;
display a representation of an interface object overlaid on a region of the display generated by the application;
receive a user input to select data displayed on the display generated by the application;
load the selected data into a data store of the interface object;
receive a user transition input to cause the application to transition to generate a different display or to execute a different loaded application to generate a different display, the different display representing a different computer program state;
maintain the representation of the interface object overlaid on the different display;
receive a user unloading input to select to unload at least some of the stored data for use in the different computer state; and
unload the data as an input to the application displaying the different display in the different computer state.

24. Apparatus for transferring data from a first computer program state when an program is generating a display on a user interface, the apparatus comprising:
at least one processor; and
a memory storing instructions, which instructions being executable by the at least one processor to:
execute an interface object to:
load at least one application;
execute one of the loaded applications in a first computer program state to generate a display on a user interface;
display a representation of an interface object overlaid on a region of the display generated by the application;
receive a user input to select data displayed on the display generated by the application;
load the selected data into a data store of the interface object;
receive a user transition input to cause the application to transition to generate a different display or to execute a different loaded application to generate a different display, the different display representing a different computer program state;
maintain the representation of the interface object overlaid on the different display;
receive a user unloading input to select to unload at least some of the stored data for use in the different computer state; and
unload the data as an input to the application displaying the different display in the different computer state.

25. A non-transient storage medium storing processor executable code for execution by a processor to executing an interface object to:
display a representation of an interface object overlaid on a region of the display generated by the program;
receive a user input to select data displayed on the display generated by the program;
load the selected data into a data store of the interface object;
receive a user transition input to cause the program to transition to generate a different display or to execute a different program to generate a different display, the different display representing a different computer program state;
maintain the representation of the interface object overlaid on the different display;
receive a user unloading input to select to unload at least some of the stored data for use in the different computer state; and
unload the data as an input to the program displaying the different display in the different computer state.

26. A non-transient storage medium storing processor executable code for execution by a processor to executing an interface object to:
execute one of the loaded applications in a first computer program state to generate a display on a user interface;
display a representation of an interface object overlaid on a region of the display generated by the application;
receive a user input to select data displayed on the display generated by the application;
load the selected data into a data store of the interface object;
receive a user transition input to cause the application to transition to generate a different display or to execute a different loaded application to generate a different display, the different display representing a different computer program state;
maintain the representation of the interface object overlaid on the different display;
receive a user unloading input to select to unload at least some of the stored data for use in the different computer state; and
unload the data as an input to the application displaying the different display in the different computer state.
